(19) United States
(12) Patent Application Publication
(10) Pub. No.: US 2018/0222215 A1
(43) Pub. Date: Aug. 9, 2018

(54) PRINTING SYSTEM

(71) Applicant: Océ Holding B.V., Venlo (NL)

(72) Inventor: Johan SCHUTTEN, Venlo (NL)

(73) Assignee: Océ Holding B.V., Venlo (NL)

(21) Appl. No.: 15/885,427

(22) Filed: Jan. 31, 2018

(30) Foreign Application Priority Data
Feb. 8, 2017 (EP) 17155227.6

(51) Int. Cl. B41J 11/00

(52) U.S. Cl. CPC B41J 11/002; B41J 11/007

(57) ABSTRACT

A printing system includes a printing stage having a print head arrangement for applying marking material onto a media, a media transport system arranged to advance the media with non-uniform velocity through the printing stage in a media transport direction and a curing stage disposed downstream of the printing stage in the media transport direction for curing the marking material. A blouse forming stage is disposed between the printing stage and the curing stage and an auxiliary media transport system is provided for advancing the media with uniform velocity through the curing stage.

The invention relates to a printing system comprising:
a printing stage having a print head arrangement for applying marking material onto a media;
a media transport system arranged to advance the media with non-uniform velocity through the printing stage in a media transport direction; and
a curing stage disposed downstream of the printing stage in the media transport direction for curing the marking material.

WO 2015/028355 A1 describes a printing system of this type wherein a scanning-type print head arrangement is provided for scanning the media in a main scanning direction transverse to the media transport direction, and the media transport system advances the media step-wise, so that an image is printed onto the media in subsequent swathes. The curing stage may comprise either a scanning-type curing system which scans the media in the main scanning direction similarly as the print head arrangement, or a page-wide curing system which is stationary and cures the marking material on the entire width of the media while the media is moved through the curing stage.

A scanning-type curing system has the drawback that a banding phenomenon may occur due to abrupt changes in the gloss of the printed image at the borderline between subsequent swathes that have been cured at different timings. A stationary, page-wide curing system has the drawback that the curing time becomes non-uniform due to the step-wise movement of the media.

It is an object of the invention to provide a printing system with an improved curing function.

In order to achieve this object, according to the invention, a blouse forming stage is disposed between the printing stage and the curing stage, and an auxiliary media transport system is provided for advancing the media with uniform velocity through the curing stage.

The blouse forming stage permits to absorb speed differences between the advance of the media in the printing stage and in the curing stage. Thus, even when the media is advanced step-wise in the printing stage, as is required in case of a scanning-type print head arrangement, the media may be advanced with uniform speed in the curing stage, so that the curing time, i. e. the time during which the marking material on the media is exposed to the curing system, is the same for each point on the media. Thus, the marking material can be cured smoothly and uniformly.

More specific optional features of the invention are indicated in the dependent claims.

The invention is applicable to a large variety of different printing technologies, including ink jet printing, e.g. printing with UV-curable inks, UV-gelling inks, and the like.

UV-gelling ink gels as soon as droplets of the UV-gelling ink are ejected from the print head and/or contact a surface of a medium. For example, the UV-gelling ink may be ejected at an elevated temperature in the print head arrangement and may start to gel upon cooling. In a gelled state, the ink droplets do not spread and remain on the medium as long as no significant mechanical impact is imparted on the gelled droplets. Thus, a medium with gelled droplets may be transported to an UV-curing system without negatively impacting the print quality.

Using non-gelling UV-curable inks may be applied as well. For example, an initial curing with low UV-radiation dosage may be applied during the printing stage to thicken and fixate the applied UV-curable ink without fully curing the ink. Full curing may then be performed in the later curing stage.

Similarly, a large variety of different curing systems may be used, including radiation type curing systems in which the media is exposed to radiation such as visible light, UV light, and the like.

The curing profile, i.e. the energy distribution of the curing radiation in media transport direction, may be designed as desired. Nevertheless, since the media is advanced with uniform speed in the curing stage, the accumulated curing energy will be the same for the entire area of the printed image.

The blouse forming stage may be formed simply by a gap in the media support and transport system, permitting the media sheet to sag and form a blouse due to its own weight. Optionally, a suction system may be provided for assisting in the formation of the blouse by exerting an additional force onto the media sheet.

The media may be supplied in the form of an endless web or in form of cut sheets.

An embodiment example will now be described in conjunction with the drawings, wherein:

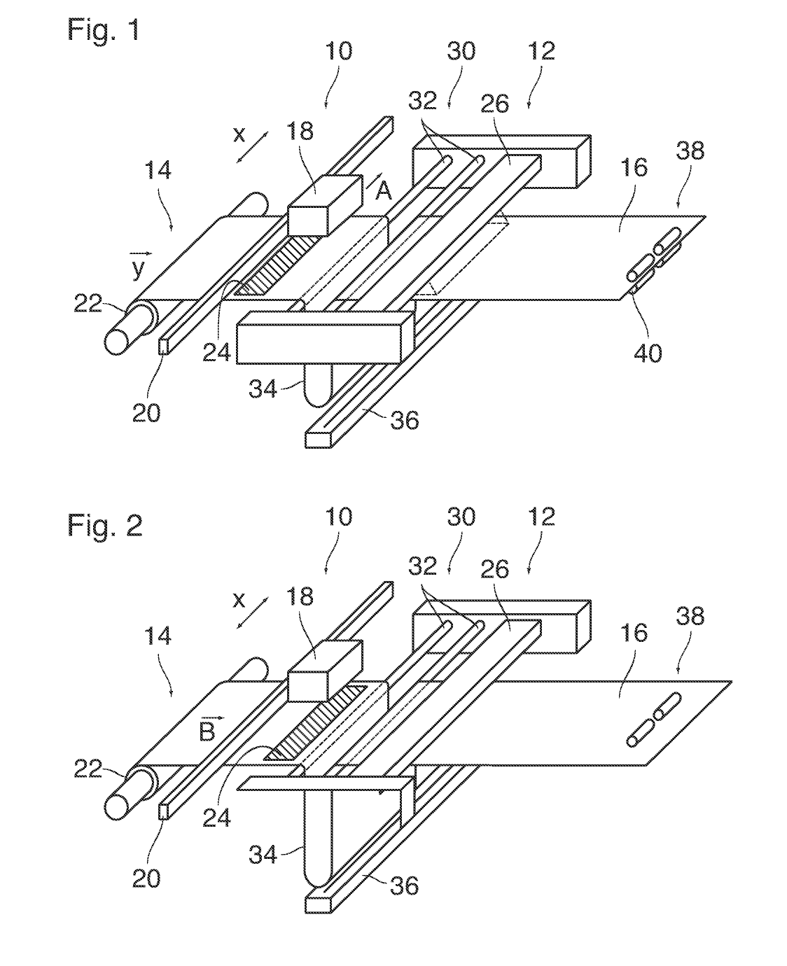

FIG. 1 is a schematic perspective view of a printing system according to the invention; and

FIG. 2 shows the printing system in a different operational state.

The printing system shown in FIG. 1 comprises a printing stage 10, a curing stage 12 and a media transport system 14 by which a recording media 16 is supplied in the form of an endless web.

The printing stage 10 comprises a scanning-type ink jet print head arrangement 18 arranged to move back and forth along a guide rail 20 in a main scanning direction x.

The media transport system 14 comprises a feed roller 22 which is driven for intermittent rotation so as to advance the media 16 in a sub-scanning and media transport direction y normal to the main scanning direction x.

In the condition shown in FIG. 1, the feed roller 22 is not rotating, while the print head arrangement 18 is moved in a direction A so as to print a swath 24 of a printed image onto the media 16. The ink or marking material used for printing the image may be a UV-gelling ink which gels as soon as the ink droplets ejected from the print head arrangement 18 hit the surface of the media 16. The gelling of the ink limits the spread of the individual ink dots, which allows for a certain delay time between the formation of an ink dot in the printing stage 10 and a later curing step in which the ink is finally cured by UV radiation in the curing stage 12.

In the curing stage 12, a curing beam 26 extends over the entire width of the media 16 and constitutes a page-wide curing system. On its bottom side, the curing beam 26 carries an array of UV curing lamps for uniformly irradiating the surface of the media 16 with UV curing light on the entire width of media.

A blouse forming stage 30 is provided between the printing stage 10 and the curing stage 12. In the blouse forming stage the media 16 is supported by two support bars 32 with a gap formed therebetween, so that the media 16 is allowed to sag under its own weight and form a blouse 34 in the gap between the support bars 32. In the example shown, the formation of the blouse 34 is further assisted by a suction bar 36 which is disposed underneath the support bars 32 and exerts an additional suction pressure onto the media sheet.

An auxiliary media transport system 38 is disposed downstream of the curing stage 12 in the media transport direction y and is constituted by a set of rollers 40 which are driven at constant speed and draw the media 16 so that it moves past the curing beam 26 with constant speed. The speed difference between the upstream part of the media 16, where the media is driven intermittently by the media transport system 14, and the downstream part, where the media is driven with uniform speed by the auxiliary media transport system 38, is absorbed by the blouse 34.

FIG. 2 shows the printing system in a state where the print head arrangement 18 has completed its pass in the direction of the arrow A and the media in the printing stage 10 is advanced by the width of the swath 24 by means of the media transport system 14, as has be symbolized by an arrow B. In this media advance step, the speed of the media is larger than the uniform speed with which the downstream part of the media is moved by the auxiliary media transport system 38, so that the blouse 34 becomes larger. When the media has been advanced by the required distance, the feed roller 22 is stopped again and the print head arrangement 18 starts to move in the opposite direction so as to print a subsequent swath of the image. Meanwhile, the downstream part of the media 16 moves through the curing stage 12 with constant speed, so that the gelled ink is finally cured uniformly on the entire width and also on the entire length of the printed image.

1. A printing system comprising:
a printing stage having a print head arrangement for applying radiation curable marking material onto a media;
a media transport system arranged to advance the media with non-uniform velocity through the printing stage in a media transport direction;
a curing stage disposed downstream of the printing stage in the media transport direction for curing the marking material, wherein the curing stage comprises a page-wide radiation type curing system;
a blouse forming stage disposed between the printing stage and the curing stage; and
an auxiliary media transport system for advancing the media with uniform velocity through the curing stage.

2. The printing system according to claim 1, wherein the curing stage comprises a stationary page-wide curing system.

3. The printing system according to claim 1, wherein the printing stage comprises a scanning-type printing system arranged to scan the media in a main scanning direction normal to the media transport direction, and the media transport system is arranged to advance the media in the printing stage step-wise.

4. The printing system according to claim 1, wherein the print head arrangement is an ink jet print head arrangement.

5. The printing system according to claim 4, wherein the print head arrangement is arranged for printing with UV-curable ink.

6. The printing system according to claim 5, wherein the print head arrangement is arranged for printing with UV-gelling ink, the UV-gelling ink being a UV-curable ink configured to gel after having been ejected from the print head arrangement.

7. The printing system according to claim 5, wherein the curing system in the curing stage is arranged to irradiate the media with UV light.

8. The printing system according to claim 1, wherein the blouse forming stage comprises support bars which support the media and form a gap in which the media is allowed to sag under its own weight so as to form a blouse.

9. The printing system according to claim 1, wherein the blouse forming stage comprises a suction bar arranged to exert a suction force onto the media so as to form a blouse.
